(19) United States
(12) Patent Application Publication
(10) Pub. No.: US 2026/0110951 A1
(43) Pub. Date: Apr. 23, 2026

(54) VEHICULAR CAMERA

(71) Applicant: Panasonic Automotive Systems Co., Ltd., Kanagawa (JP)

(72) Inventors: Yoshihiro UENO, Osaka (JP); Kazufumi MIZUSAWA, Kanagawa (JP); Futoshi SHIMIZU, Kanagawa (JP)

(73) Assignee: Panasonic Automotive Systems Co., Ltd., Kanagawa (JP)

(21) Appl. No.: 19/331,685

(22) Filed: Sep. 17, 2025

(30) Foreign Application Priority Data
Oct. 21, 2024 (JP) 2024-185204

(51) Int. Cl. G03B 17/55; H04N 23/55; H05B 3/84

(52) U.S. Cl. CPC G03B 17/55; H04N 23/55; H05B 3/84

(57) ABSTRACT

A vehicular camera includes a lens barrel having a lens including at least a first lens and a second lens, an imaging element, a circuit board, a circuit board connector, a housing, and a connector. The first lens is adjacent to the second lens and is disposed farther from the second lens in a direction along the optical axis. The lens barrel includes a heater, a piezoelectric element, and a resin member. The resin member of the lens barrel is disposed closer to the second lens than the heater of the lens barrel, is disposed closer to the second lens than the piezoelectric element of the lens barrel, and supports the heater of the lens barrel or the piezoelectric element of the lens barrel. A first thermal conductivity of the lens barrel is larger than a second thermal conductivity of the resin member.

### TECHNICAL FIELD

The present disclosure relates to a vehicular camera.

With demands for improvements in vehicle safety, introduction of autonomous driving functions and the like in recent years, development of vehicular cameras that are mounted on vehicles and capture the inside and outside of the vehicles has become active (for example, see Patent Literature 1).

### CITATION LIST

### Patent Literature

Patent Literature 1: JP2017-170303A

Patent Literature 2: JP2020-181702A

Patent Literature 3: WO2023/127197

Patent Literature 4: JP2024-53065A

### SUMMARY OF INVENTION

Required levels relating to safety, automatic driving functions, and the like, which are required for vehicles, are improved, and further improvement in performance and the like are also required for vehicular cameras.

The present disclosure relates to a technique for providing a new vehicular camera.

The present disclosure provides a vehicular camera including a lens barrel having a first tubular portion along an optical axis, and including a first end portion of the first tubular portion, a second end portion opposite to the first end portion, and a lens including at least a first lens and a second lens disposed along the optical axis; an imaging element disposed on the optical axis and closer to the second end portion than the first end portion of the first tubular portion of the lens barrel; a circuit board including a first surface and a second surface opposite to the first surface, the imaging element being disposed on the first surface; a circuit board connector disposed on the circuit board; a housing accommodating the circuit board and having a second tubular portion along the optical axis, including a third end portion of the second tubular portion and a fourth end portion opposite to the third end portion and disposed farther, than the third end portion of the second tubular portion, away from the first end portion of the first tubular portion of the lens barrel, the third end portion of the second tubular portion supporting the lens barrel; and a connector disposed in at least a part of the fourth end portion of the housing and connected to the circuit board connector. The first lens is adjacent to the second lens and is disposed farther, than the second lens, away from the first surface of the circuit board in a direction along the optical axis. The lens barrel includes a heater having a first ring shape and disposed between the first lens and the second lens along a first edge portion of the first lens, a piezoelectric element having a second ring shape and disposed between the first lens and the second lens along the first edge portion of the first lens, and a resin member having a third ring shape and disposed between the first lens and the second lens along a second edge portion of the second lens. The resin member of the lens barrel is disposed closer to the second lens than the heater of the lens barrel. The resin member of the lens barrel is disposed closer to the second lens than the piezoelectric element of the lens barrel. The resin member of the lens barrel supports the heater of the lens barrel and/or the piezoelectric element of the lens barrel. A first thermal conductivity of the lens barrel is larger than a second thermal conductivity of the resin member.

According to the present disclosure, it is possible to remove different types of foreign matter such as snow and moisture adhering to the first lens by the heater and the piezoelectric element, and it is possible to secure a field of view of the vehicular camera. In addition, since the resin member having a thermal conductivity lower than that of the lens barrel supports the heater and/or the piezoelectric element, it is possible to prevent heat from the heater from being dissipated to the outside, and to efficiently remove snow by the heater.

### BRIEF DESCRIPTION OF DRAWINGS

FIG. 1 is an example of a vehicle, and is a top view of the vehicle on which vehicular cameras are mounted;

FIG. 2 is a block diagram illustrating a connection example of the vehicular cameras provided in the vehicle illustrated in FIG. 1, a camera ECU, and a display;

FIG. 3 is another example of the vehicle, and is a schematic diagram of a cabin of the vehicle on which a vehicular camera is mounted;

FIG. 4 is a top view of the vehicle in FIG. 3;

FIG. 5 is a block diagram illustrating a connection example of the vehicular camera provided in the vehicle illustrated in FIG. 3, a camera ECU, and a display device;

FIG. 6 is a front perspective view of the vehicular camera according to a first embodiment;

FIG. 7 is a rear perspective view of the vehicular camera according to the first embodiment;

FIG. 8 is an exploded perspective view of the vehicular camera according to the first embodiment;

FIG. 9 is a top view of the vehicular camera according to the first embodiment;

FIG. 10 is a cross-sectional view taken along a line I-I in FIG. 9;

FIG. 11 is an exploded perspective view of a vehicular camera according to a second embodiment;

FIG. 12 is a cross-sectional view of the vehicular camera according to the second embodiment taken along the line I-I in FIG. 9;

FIG. 13 is an exploded perspective view of a vehicular camera according to a third embodiment;

FIG. 14 is a cross-sectional view of the vehicular camera according to the third embodiment taken along the line I-I in FIG. 9;

FIG. 15 is a circuit diagram of a circuit board;

FIG. 16 is a flowchart illustrating a power supply procedure in a vehicular camera; and

FIG. 17 is a cross-sectional view taken along the line I-I in FIG. 9 of a vehicular camera according to an embodiment having two circuit boards.

### DESCRIPTION OF EMBODIMENTS

Hereinafter, embodiments that specifically disclose a vehicular camera according to the present disclosure will be described in detail with reference to the drawings as appropriate. However, unnecessarily detailed descriptions may be omitted. For example, detailed descriptions of already well-known matters and redundant descriptions of substantially the same configuration may be omitted. This is to avoid unnecessary redundancy of the following descriptions and to facilitate understanding of those skilled in the art. It should be noted that the accompanying drawings and the following description are provided for those skilled in the art to sufficiently understand the present disclosure, and are not intended to limit the subject matter described in the claims.

### Vehicle on which Vehicular Camera is Mounted

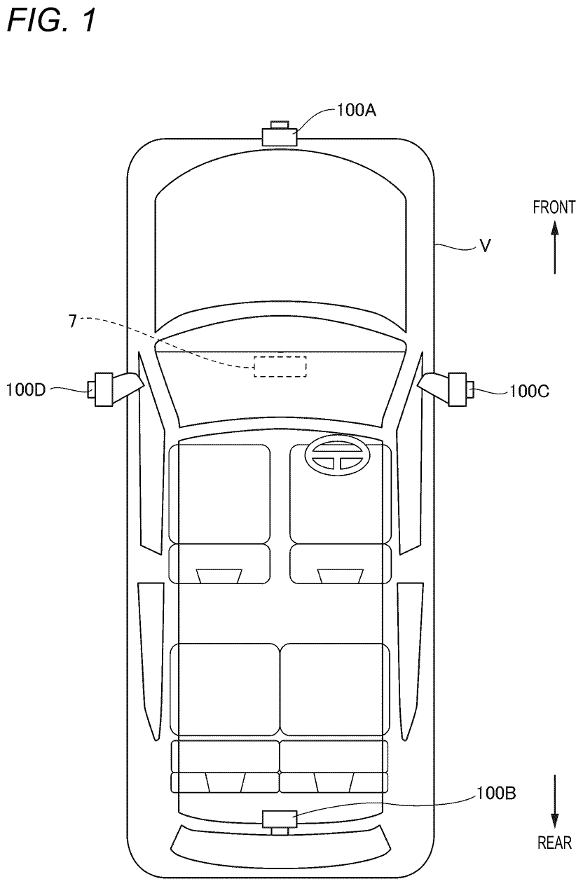

FIG. 1 is an example of a vehicle, and is a top view of the vehicle on which vehicular cameras are mounted. As a vehicular camera 100, a vehicular camera 100A, a vehicular camera 100B, a vehicular camera 100C, and a vehicular camera 100D are mounted on a vehicle V. The vehicular camera 100A is a front camera, the vehicular camera 100B is a rear camera, the vehicular camera 100C is a right side camera, and the vehicular camera 100D is a left side camera. The vehicular cameras 100A to 100D are, for example, wide-angle cameras having an angle of view of about 180°, and are disposed to capture images showing an entire periphery of the vehicle V.

For example, the vehicular camera 100A is provided in a front grille of the vehicle V, and captures an image of a front region in a direction of looking down obliquely with respect to the ground. The vehicular camera 100B is provided in a roof spoiler of the vehicle V, and captures an image of a rear region in a direction of looking down obliquely with respect to the ground. The vehicular camera 100C and the vehicular camera 100D are provided in side mirrors of the vehicle V, and capture images of lateral regions in directions of looking down obliquely with respect to the ground, respectively.

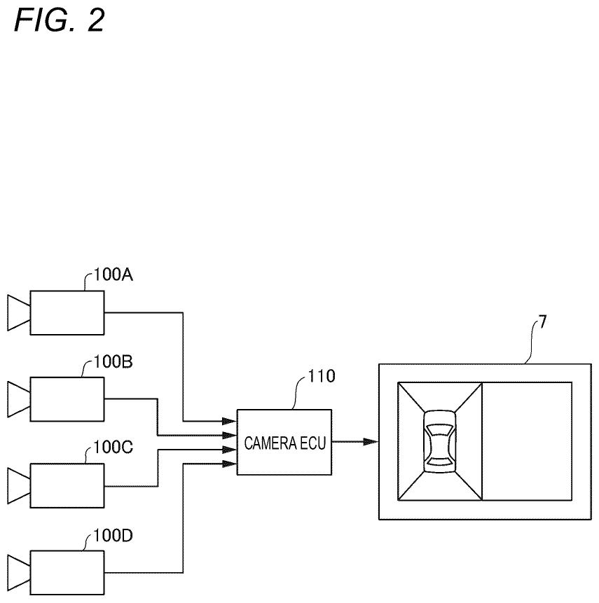

FIG. 2 is a block diagram illustrating a connection example of the vehicular cameras 100A to 100D provided in the vehicle V illustrated in FIG. 1, a camera ECU 110, and a display 7. The camera electronic control unit (ECU) 110 in FIG. 2 synthesizes the images captured by the vehicular cameras 100A to 100D, and displays a synthesized image on the display 7 of a navigation system disposed on an instrument panel, for example. An occupant can visually recognize the display 7 and check a situation around the vehicle V.

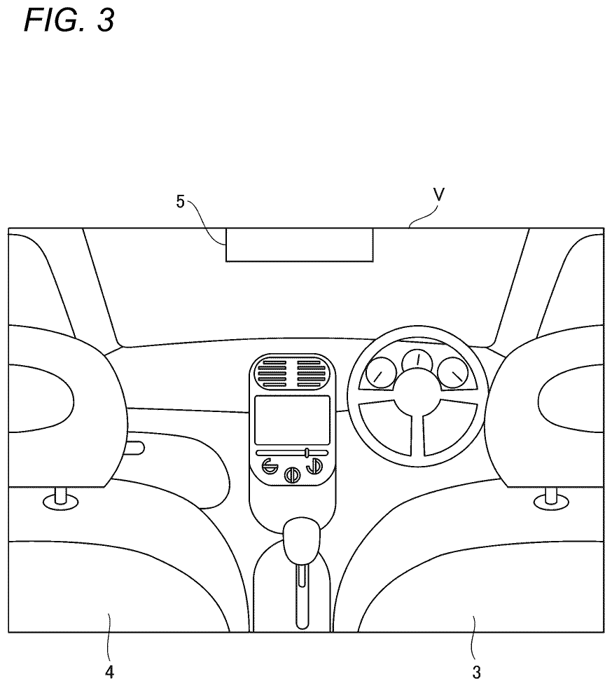

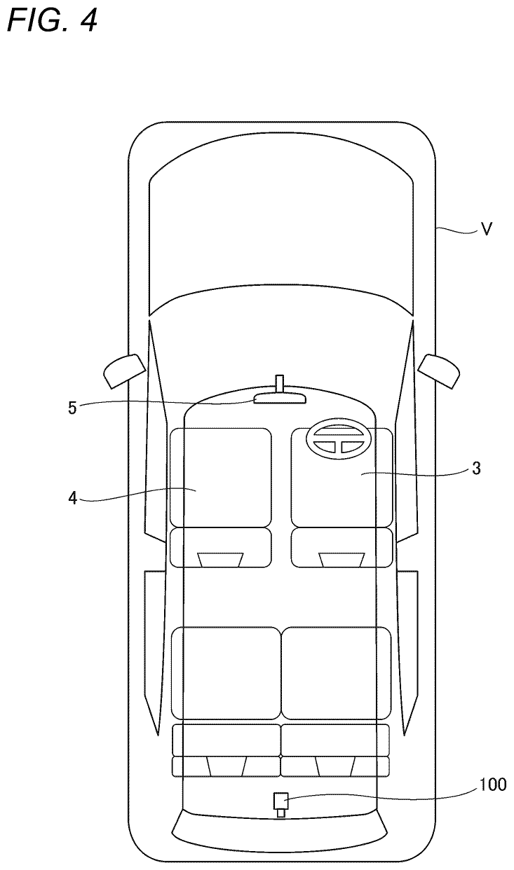

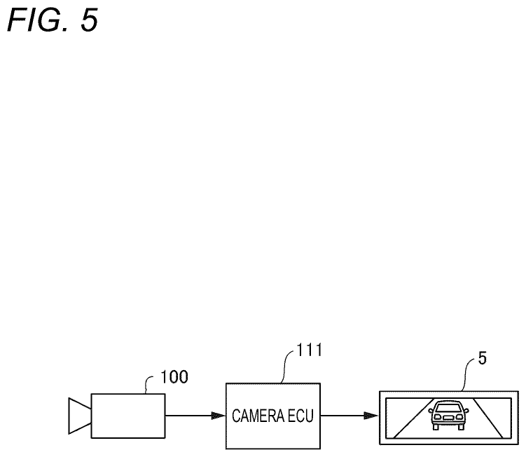

FIG. 3 is another example of the vehicle, and is a schematic diagram of a cabin of the vehicle on which the vehicular camera is mounted, and FIG. 4 is a top view of the vehicle in FIG. 3. The vehicle V includes a display device 5 (for example, an electronic rearview mirror) at an attachment position of a rearview mirror, which is a front portion between a driver's seat 3 and a passenger seat 4 in a cabin 2. Further, the vehicle V is provided with the vehicular camera 100 at a rear side of a vehicle body. FIG. 5 is a block diagram illustrating a connection example of the vehicular camera 100 provided in the vehicle V illustrated in FIG. 3, a camera ECU 111, and the display device 5. The camera electronic control unit (ECU) 111 in FIG. 4 processes an image captured by the vehicular camera 100, and the display device 5 displays the image. The occupant can visually recognize the display device 5 and check a rear situation of the vehicle V.

### First Embodiment

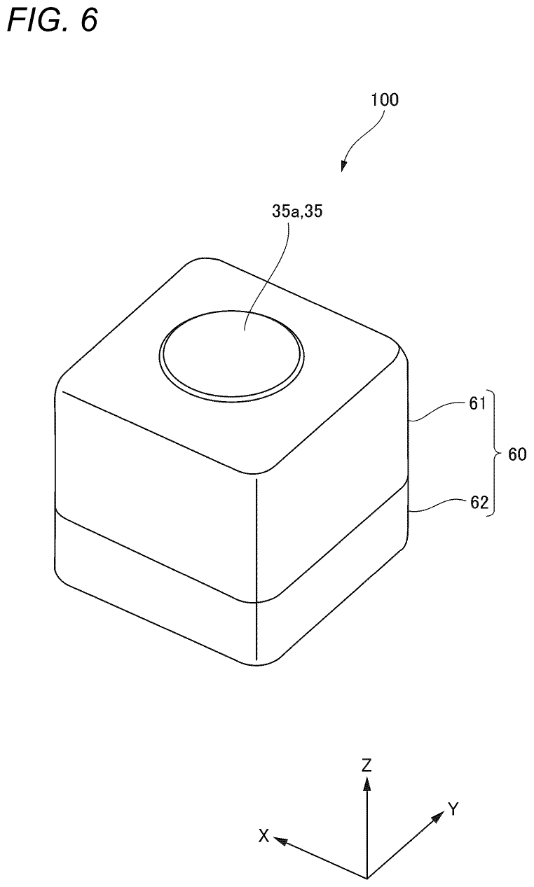

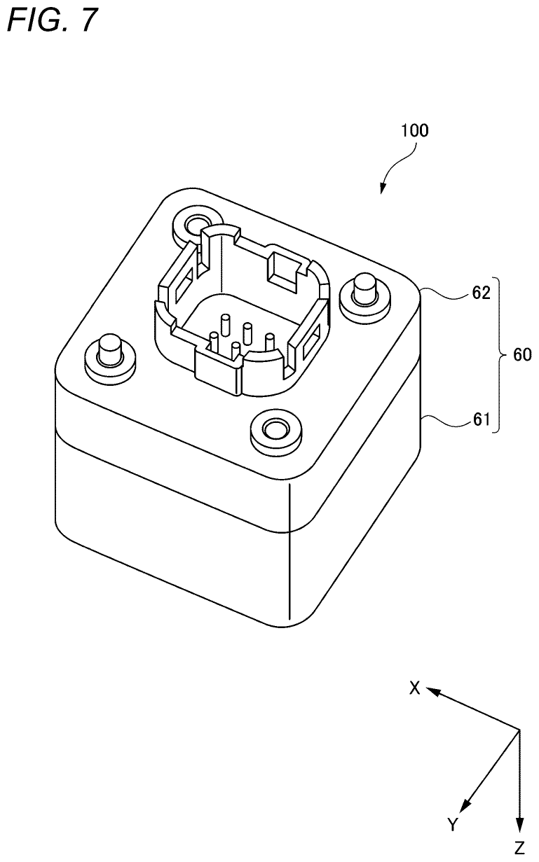

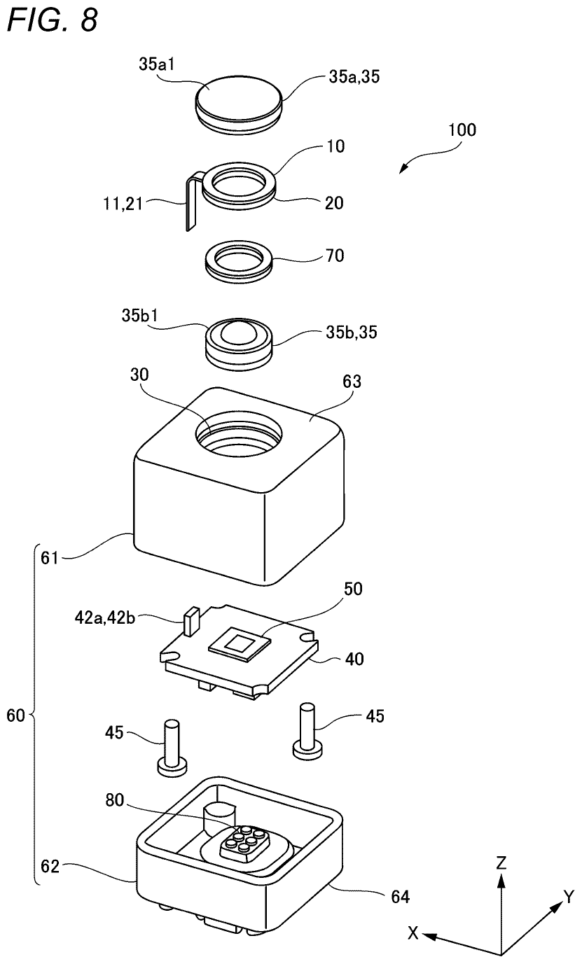

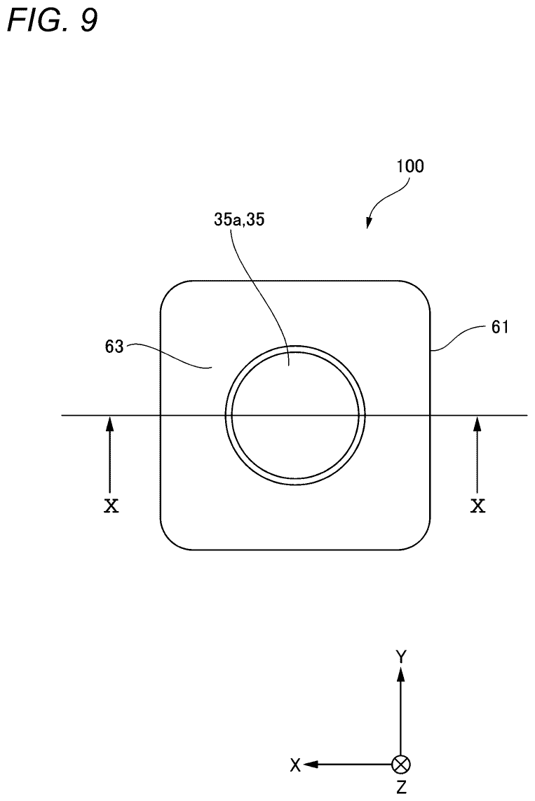

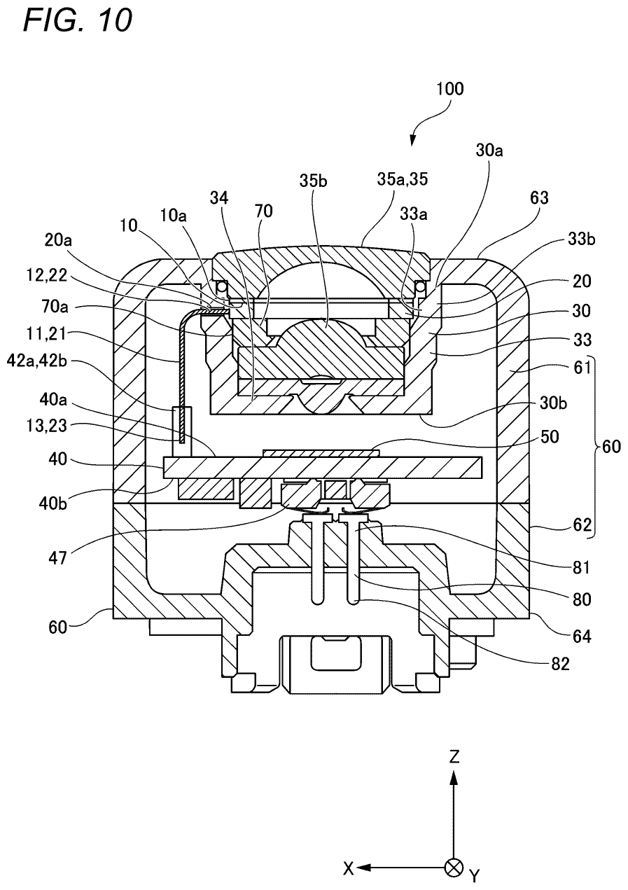

FIG. 6 is a front perspective view of the vehicular camera 100 according to a first embodiment. FIG. 7 is a rear perspective view of the vehicular camera 100 according to the first embodiment. FIG. 8 is an exploded perspective view of the vehicular camera 100 according to the embodiment. FIG. 9 is a top view of the vehicular camera 100 according to the embodiment. FIG. 10 is a cross-sectional view taken along a line I-I in FIG. 9. Coordinates including an X axis along one side of the vehicular camera 100, a Y axis orthogonal to the X axis and along another side of the vehicular camera 100, and a Z axis orthogonal to the X axis and the Y axis and along a height direction of the vehicular camera 100 are defined, and are used in the following description.

The vehicular camera 100 according to the present embodiment includes a lens barrel 30, a circuit board 40, an imaging element 50, a housing 60, and a connector 80.

The lens barrel 30 has a first tubular portion along an optical axis L (a direction orthogonal to the sheet of FIG. 9 and along the Z axis), and includes a side wall 33 surrounding the optical axis L, and a bottom wall 34 facing the circuit board 40 and the imaging element 50, as illustrated in FIG. 10. The lens barrel 30 further includes a first end portion 30a of the first tubular portion and a second end portion 30b opposite to the first end portion 30a. The first end portion 30a includes a distal end portion of the side wall 33, and the second end portion 30b includes a bottom surface of the bottom wall 34.

The lens barrel 30 includes, at a position radially inward of the side wall 33, a lens 35 that is accommodated inside the lens barrel 30 and disposed on the optical axis L. The lens 35 includes at least a first lens 35a and a second lens 35b disposed along the optical axis L. The first lens 35a and the second lens 35b are arranged in a state in which respective optical axes L are aligned with each other, and are used for capturing images of the inside and outside of the vehicle body of the vehicle V. The lens 35 may include three or more lenses.

The first lens 35a is adjacent to the second lens 35b, and is disposed farther, than the second lens 35b, away from a first surface 40a of the circuit board 40 in a direction along the optical axis L.

The imaging element 50 is disposed in an internal space of the housing 60 on the optical axis L and closer to the second end portion 30b than the first end portion 30a of the lens barrel 30. The imaging element 50 is electrically connected to a circuit of the circuit board 40, and can capture an image by directing external light to the imaging element 50. The imaging element 50 may be, for example, a complementary metal-oxide-semiconductor (CMOS) image sensor.

The circuit board 40 is disposed in the internal space of the housing 60, and includes a first surface 40a and a second surface 40b opposite to the first surface 40a. However, two or more circuit boards may be provided. The imaging element 50 is disposed on the first surface 40a of the circuit board 40.

The circuit board 40 has a first shape in a plan view. The first shape in a plan view is a shape when viewed in a direction from the first surface 40a to the second surface 40b of the circuit board 40. The first shape is, for example, a quadrangular shape as in the embodiment, but may be a polygonal shape having five or more sides. The circuit board 40 is fixed to the lens barrel 30 by screws 45.

The circuit board connector 47 is disposed on the second surface 40b of the circuit board 40. Details of the circuit board connector 47 will be described later.

The housing 60 is a tubular member having the internal space, and serves to accommodate at least the circuit board 40 and the imaging element 50. The housing 60 has a second tubular portion along the optical axis L, and includes a first housing portion 61 integrally formed with the lens barrel 30 to surround an outer periphery of the lens barrel 30, and a second housing portion 62 welded to the first housing portion 61. The housing 60 has a third end portion 63 on the first housing portion 61 side and a fourth end portion 64 on the second housing portion 62 side. The third end portion 63 is connected to the first end portion 30a of the lens barrel 30. The fourth end portion 64 is opposite to the third end portion 63 in the direction along the optical axis L. In the present embodiment, the housing 60 has a rectangular tubular shape, but is not limited thereto, and may have a polygonal tubular shape other than the rectangular tubular shape, a circular or elliptical tubular shape, or another tubular shape.

The connector 80 is disposed in at least a part of the fourth end portion 64 of the housing 60, is connected to the circuit board connector 47, and supplies external power to the circuit board connector 47.

The first housing portion 61 and the second housing portion 62 are welded while accommodating at least the circuit board 40 and the imaging element 50. The welding is performed by, for example, laser welding. The first housing portion 61 and the second housing portion 62 may be integrally formed from the beginning.

The lens barrel 30 and the housing 60 are formed of, for example, conductive metal. Since the lens barrel 30 and the housing 60 are formed of a conductive material, the lens barrel 30 and the housing 60 can serve to shield noise inside and outside the vehicular camera 100.

The lens barrel 30 of the vehicular camera 100 of the present embodiment further includes a heater 10, a piezoelectric element 20, and a resin member 70. The heater 10, the piezoelectric element 20, and the resin member 70 are arranged in this order along the optical axis L, and are disposed inside the side wall 33 in a radial direction.

The heater 10 is a member that is disposed between the first lens 35a and the second lens 35b along a first edge portion 35a1 of the first lens 35a and has a first ring shape. The heater 10 can generate heat by power, and mainly melts and removes snow adhering to the first lens 35a by heat generation. By such an action of the heater 10, a field of view of the vehicular camera 100 can be secured. The heater 10 may be formed of, for example, a positive temperature coefficient (PTC) heater. The PTC heater can perform self-temperature control. The heater unit 10 may be, for example, a metal heater.

The piezoelectric element 20 is a member that is disposed between the first lens 35a and the second lens 35b along the first edge portion 35a1 of the first lens 35a and has a second ring shape. The piezoelectric element 20 can be vibrated by power, and mainly removes moisture such as raindrops adhering to the first lens 35a by the vibration. By such an action of the piezoelectric element 20, the field of view of the vehicular camera 100 can be secured. The piezoelectric element 20 can be formed by a general piezoelectric element or the like.

The resin member 70 is a member that is disposed between the first lens 35a and the second lens 35b along a second edge portion 35b1 of the second lens 35b and has a third ring shape. The resin member 70 can be formed by injection molding a general resin material such as polycarbonate or nylon.

The resin member 70 is disposed closer to the second lens 35b than the heater 10 and is disposed closer to the second lens 35b than the piezoelectric element 20. Further, the resin member 70 supports the heater 10 and/or the piezoelectric element 20.

Specifically, in the present embodiment, the piezoelectric element 20 is disposed closer to the imaging element 50 than the heater 10 in the direction along the optical axis L. The heater 10 is disposed in contact with the first edge portion 35a1 of the first lens 35a, the piezoelectric element 20 is disposed in contact with the heater 10, and the resin member 70 is disposed in contact with the piezoelectric element 20.

A first thermal conductivity of the lens barrel 30 is larger than a second thermal conductivity of the resin member 70. For example, when the lens barrel 30 is formed of a conductive material such as metal, the first thermal conductivity is basically larger than the second thermal conductivity of the resin member 70 formed of a resin material with poor conductivity.

According to the present embodiment, it is possible to remove different types of foreign matter such as snow and moisture adhering to the first lens 35a by the heater 10 and the piezoelectric element 20, and it is possible to secure the field of view of the vehicular camera 100. Specifically, the heater 10 in contact with the first edge portion 35a1 of the first lens 35a can melt and remove snow adhering to the first lens 35a by heat generation. In addition, the piezoelectric element 20 in contact with the heater 10 can remove moisture such as raindrops adhering to the first lens 35a by vibration via the heater 10.

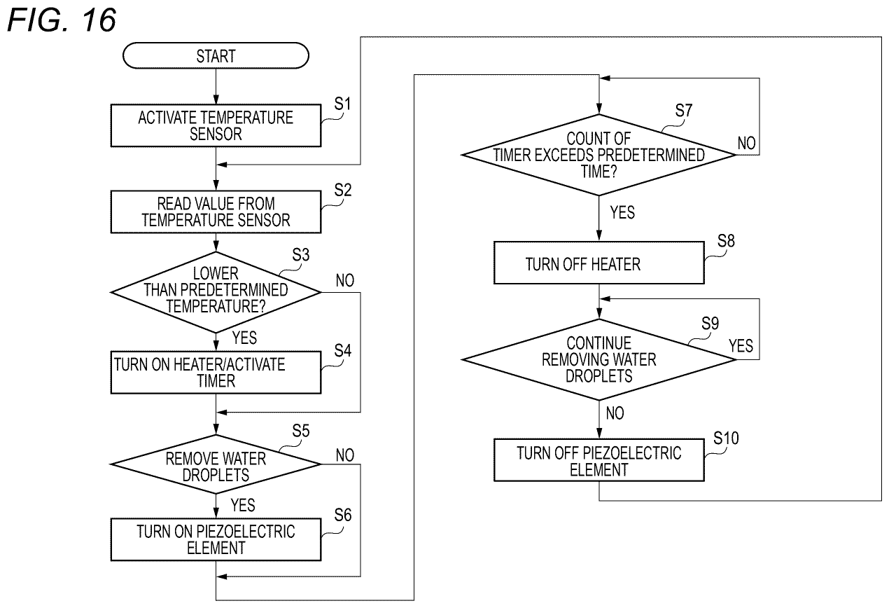

A temperature sensor (not illustrated) may be provided near the first lens 35a. The temperature sensor may detect temperature of the first lens 35a, and control the heater 10 and the piezoelectric element 20 to be turned on/off based on the detected temperature (see FIG. 16).

The resin member 70 having a thermal conductivity smaller than that of the lens barrel 30 supports the heater 10 and/or the piezoelectric element 20. In the present embodiment, the resin member 70 indirectly supports the heater 10 via the piezoelectric element 20. Accordingly, the heat from the heater 10 can be prevented from being dissipated to the outside, and the snow can be efficiently removed by the heater 10.

In particular, in the present embodiment, the piezoelectric element 20 is disposed closer to the imaging element 50 than the heater 10 in the direction along the optical axis L. Accordingly, the heater 10 can be disposed closer to the first lens 35a than the piezoelectric element 20, and the snow can be efficiently removed by the heat from the heater 10.

The heater 10 is disposed in contact with the first edge portion 35a1 of the first lens 35a, the piezoelectric element 20 is disposed in contact with the heater 10, and the resin member 70 is disposed in contact with the piezoelectric element 20. Accordingly, the heater 10, the piezoelectric element 20, and the resin member 70 can be disposed in a limited space.

Further, the first tubular portion of the lens barrel 30, particularly the side wall 33, includes an inner surface 33a on the inside as viewed from the optical axis L and an outer surface 33b on the outside as viewed from the optical axis L. The heater 10, the piezoelectric element 20, and the resin member 70 are disposed along the inner surface 33a of the side wall 33 of the lens barrel 30. Specifically, a first outer peripheral edge 10a of the heater 10 is disposed along the inner surface 33a of the lens barrel 30. A second outer peripheral edge 20a of the piezoelectric element 20 is disposed along the inner surface 33a of the lens barrel 30. A third outer peripheral edge 70a of the resin member 70 is disposed along the inner surface 33a of the lens barrel 30. Accordingly, the heater 10, the piezoelectric element 20, and the resin member 70 can be stably disposed on the side wall 33 of the lens barrel 30.

As described above, the first lens 35a is a lens farthest from the imaging element 50, the heater 10 can heat the first lens 35a, and the piezoelectric element 20 can vibrate the first lens 35a. Accordingly, it is possible to remove the foreign matter of the first lens 35a closest to an object to be captured, of the lens 35, by the heater 10 and the piezoelectric element 20, and to secure the field of view of the vehicular camera 100.

The heater 10 and the piezoelectric element 20 will be described in more detail. The heater 10 includes a first conducting wire 11 having a first conducting wire end 12 and a second conducting wire end 13 opposite to the first conducting wire end 12, the first conducting wire end 12 being connected to the heater 10 and the second conducting wire end 13 being connected to the circuit board 40. Further, the piezoelectric element 20 includes a second conducting wire 21 having a third conducting wire end 22 and a fourth conducting wire end 23 opposite to the third conducting wire end 22, the third conducting wire end 22 being connected to the piezoelectric element 20 and the fourth conducting wire end 23 being connected to the circuit board 40.

The power is required to drive the heater 10 and the piezoelectric element 20, and with the above configuration, the power required for the heater10 and the piezoelectric element 20 can be supplied from the circuit board 40.

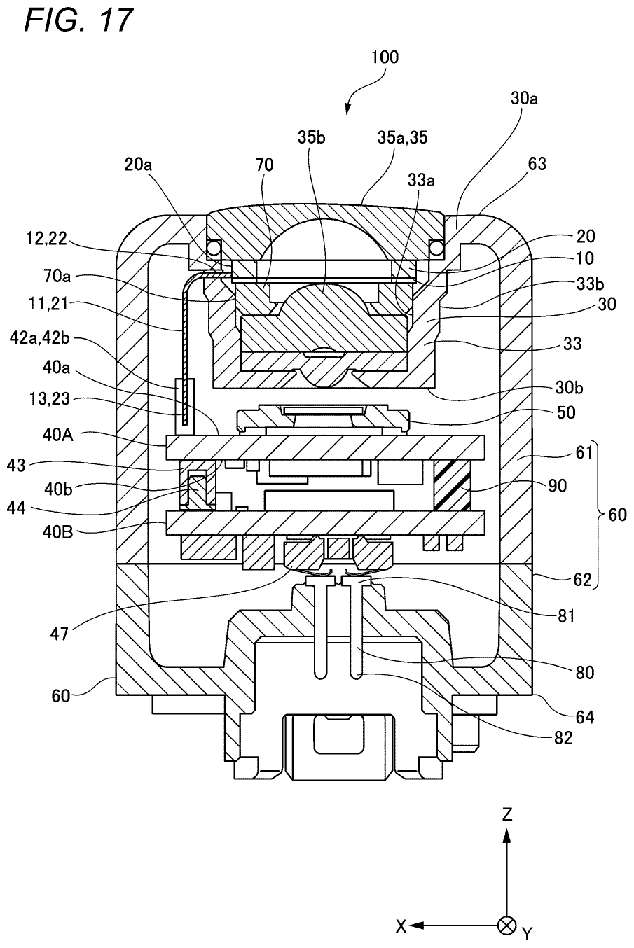

The circuit board 40 includes a conducting wire connector 42a and a conducting wire connector 42b on the first surface 40a or the second surface 40b of the circuit board 40, and the first conducting wire 11 and the second conducting wire 21 are connected to the conducting wire connector 42a and the conducting wire connector 42b (see FIG. 17).

As illustrated in FIG. 10, at least a part of the first conducting wire 11 of the heater 10 and at least a part of the second conducting wire 21 of the piezoelectric element 20 described above pass outward of the outer surface 33b of the first tubular portion of the lens barrel 30 and are connected to the circuit board 40. That is, at least a part of the first conducting wire 11 and at least a part of the second conducting wire 21 are disposed between the side wall 33 of the lens barrel 30 and the first housing portion 61 of the housing 60. Accordingly, the first conducting wire 11 and the second conducting wire 21 can be disposed in a space between the lens barrel 30 and the housing 60, and the space can be effectively used.

Each of the first conducting wire 11 of the heater 10 and the second conducting wire 21 of the piezoelectric element 20 may be formed of a flexible printed circuit board. Accordingly, the first conducting wire 11 and the second conducting wire 21 can be easily configured. In this case, the flexible printed circuit board of the first conducting wire 11 and the flexible printed circuit board of the second conducting wire 21 may be integrated. Accordingly, the first conducting wire 11 and the second conducting wire 21 can be integrated, and the vehicular camera 100 can be easily assembled.

It is assumed that the power for driving the heater 10 is first power and the power for driving the piezoelectric element 20 is second power. In this case, after the first power is supplied to the heater 10 via the first conducting wire 11, the second power may be supplied to the piezoelectric element 20 via the second conducting wire 21. Accordingly, after the foreign matter such as snow adhering to the first lens 35a is melted by the heat form the heater 10 to form moisture, the moisture can be removed by the vibration of the piezoelectric element 20, and the foreign matter can be efficiently removed.

The first power and the second power can be supplied from the connector 80 and the circuit board connector 47. Accordingly, the first power and the second power can be supplied from the outside.

### Second Embodiment

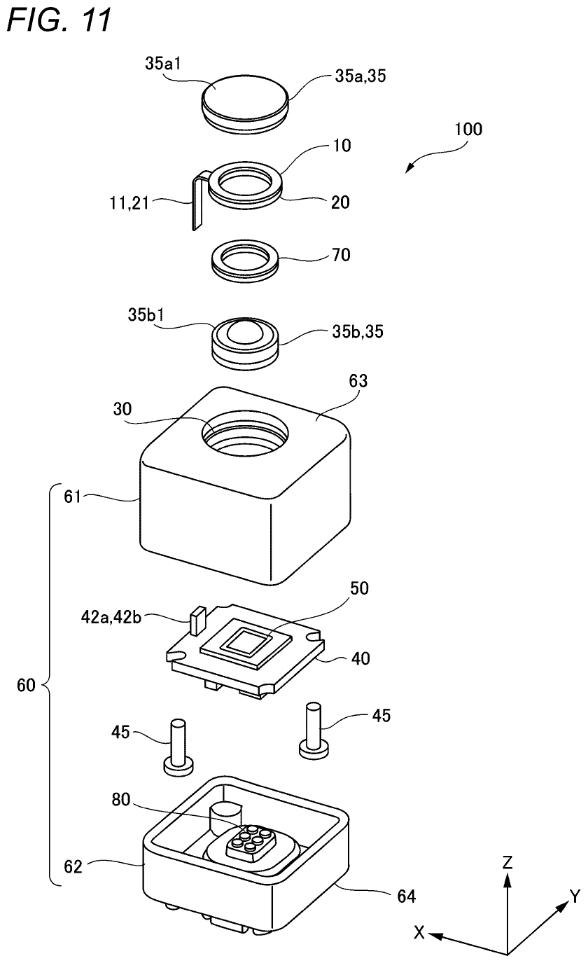

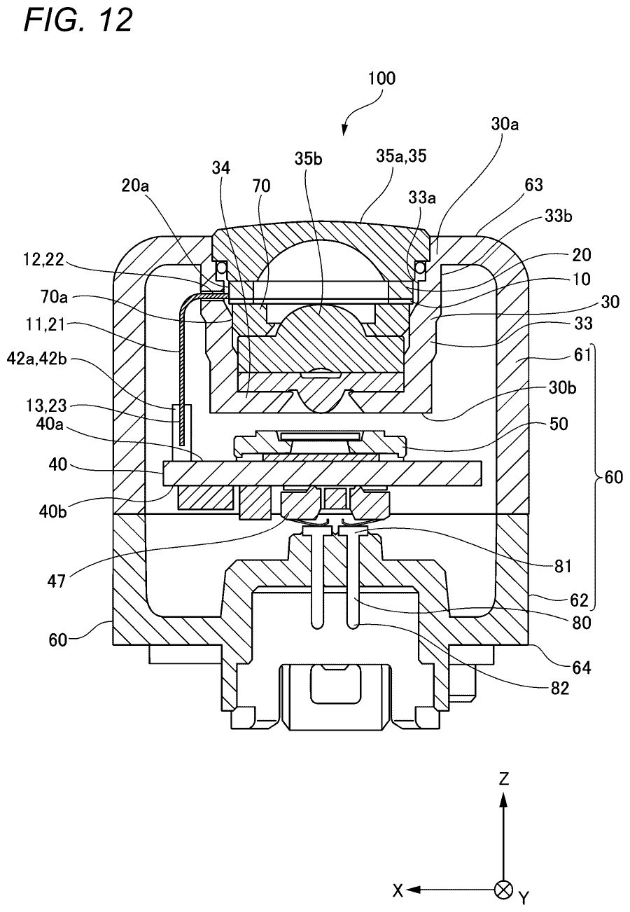

FIG. 11 is an exploded perspective view of the vehicular camera 100 according to a second embodiment, and FIG. 12 is a cross-sectional view of the vehicular camera 100 according to the second embodiment taken along the line I-I in FIG. 9. The appearance of the vehicular camera 100 according to the second embodiment is the same as the appearance in the first embodiment.

In the present embodiment, unlike the first embodiment, the heater 10 is disposed closer to the imaging element 50 than the piezoelectric element 20 in the direction along the optical axis L. That is, the arrangement order of the heater 10 and the piezoelectric element 20 in the present embodiment is opposite to the arrangement order in the first embodiment.

Accordingly, the piezoelectric element 20 can be disposed closer to the first lens 35a than the heater 10, and the moisture can be efficiently removed by the vibration of the piezoelectric element 20.

Specifically, the piezoelectric element 20 is disposed in contact with the first edge portion 35a1 of the first lens 35a, the heater 10 is disposed in contact with the piezoelectric element 20, and the resin member 70 is disposed in contact with the heater 10. Accordingly, the piezoelectric element 20, the heater 10, and the resin member 70 can be disposed in a limited space.

### Third Embodiment

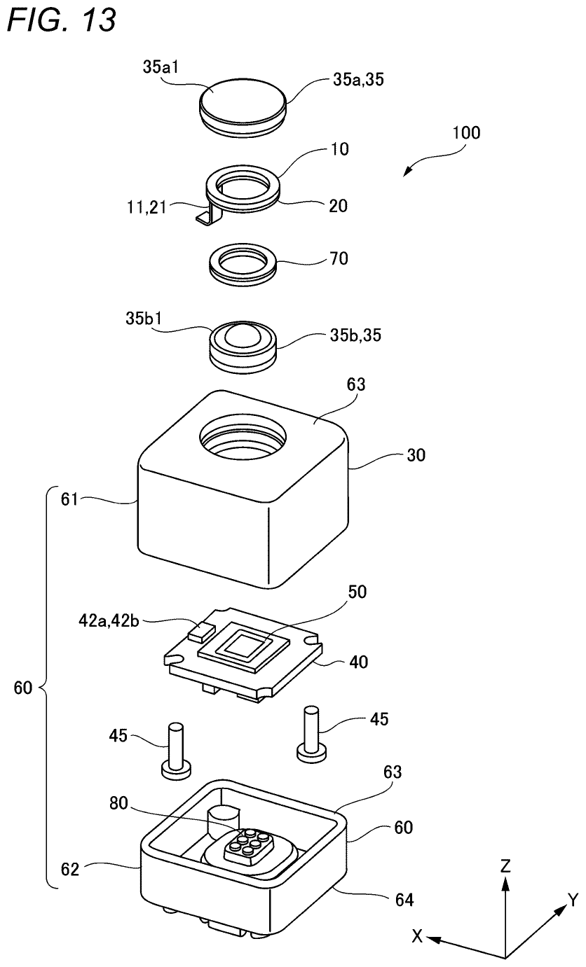

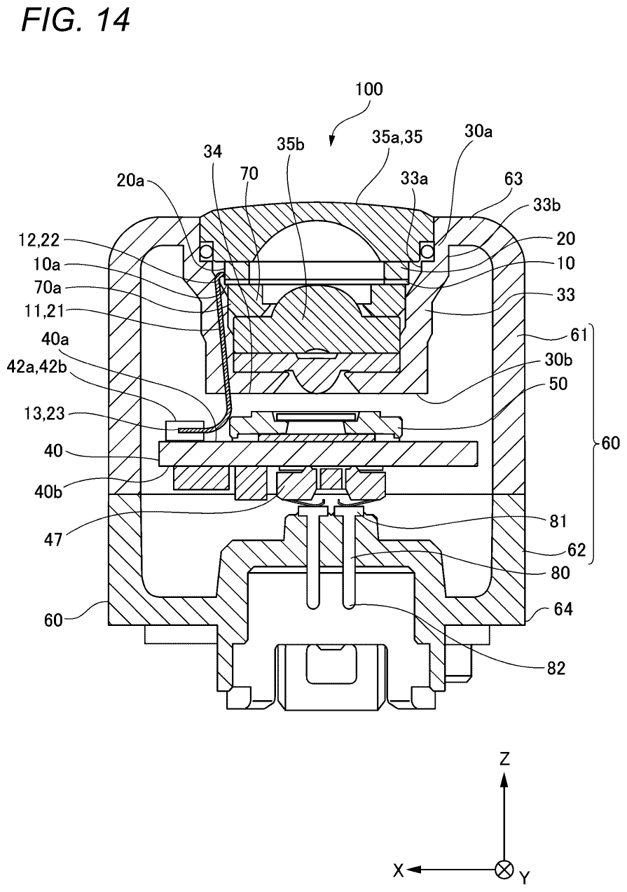

FIG. 13 is an exploded perspective view of the vehicular camera 100 according to a third embodiment, and FIG. 14 is a cross-sectional view of the vehicular camera 100 according to the third embodiment taken along the line I-I in FIG. 9. The appearance of the vehicular camera 100 according to the third embodiment is the same as the appearance in the first embodiment and the second embodiment.

In the present embodiment, unlike the first embodiment and the second embodiment, at least a part of the first conducting wire 11 of the heater 10 and at least a part of the second conducting wire 21 of the piezoelectric element 20 pass inward of the inner surface 33a of the first tubular portion of the lens barrel 30 and are connected to the circuit board 40. That is, at least a part of the first conducting wire 11 and at least a part of the second conducting wire 21 are disposed inside the lens barrel 30.

Accordingly, the first conducting wire 11 and the second conducting wire 21 can be disposed inside the inner surface 33a, and lengths of the first conducting wire 11 and the second conducting wire 21 can be shortened. The arrangement order of the heater 10 and the piezoelectric element 20 of the present embodiment is the same as the arrangement order in the second embodiment, but may be the same as the arrangement order in the first embodiment.

### Circuit Board

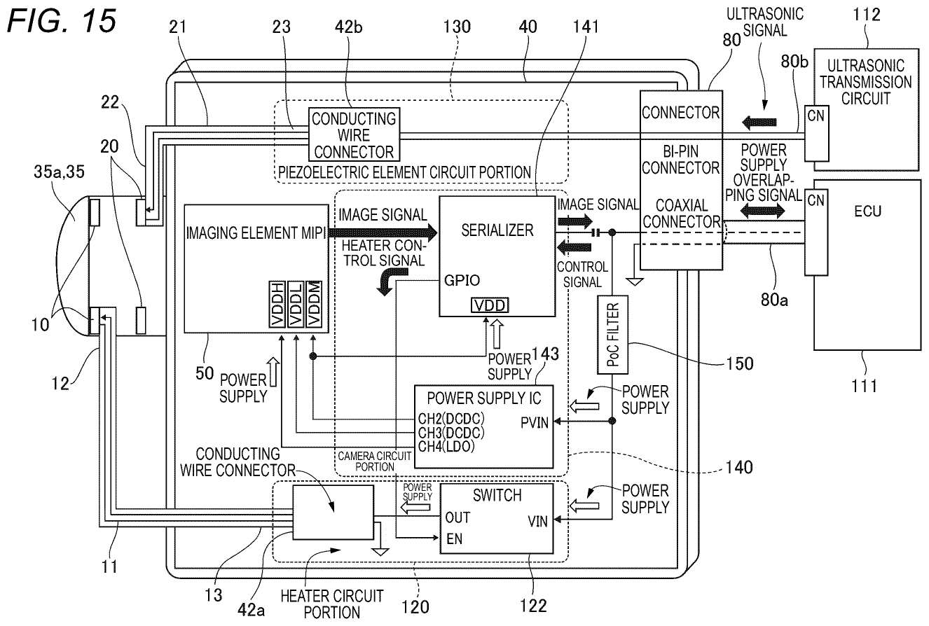

FIG. 15 is a detailed circuit diagram of the circuit board 40. FIG. 15 schematically illustrates electrical connection of each portion, and does not illustrate an arrangement structure of either the first surface 40a or the second surface 40b of the circuit board 40.

The circuit board 40 includes a heater circuit portion 120 having a function of supplying power to the heater 10, a piezoelectric element circuit portion 130 having a function of supplying power to the piezoelectric element 20, and a camera circuit portion 140 having a function of mainly supplying power to a portion other than the heater 10 and the piezoelectric element 20 of the vehicular camera 100.

The heater circuit portion 120 includes a conducting wire connector 121 and a switch 122. The conducting wire connector 121 is disposed on the circuit board 40, is connected to the second conducting wire end 13 of the first conducting wire 11 and is also connected to the circuit board connector 47 (see FIG. 10). The conducting wire connector 121 functions as a conducting wire connection portion that connects the first conducting wire 11 to the circuit board 40.

The switch 122 is disposed on the circuit board 40, is electrically connected to the circuit board connector 47 and the conducting wire connector 121, and has a function of increasing or decreasing a voltage and/or current supplied to the heater 10.

The connector 80 includes a coaxial connector 80a capable of supplying both power and signals. The coaxial connector 80a can receive a part of original power from the vehicle V, supply the power to the circuit board 40, and output power of an image signal output from the imaging element 50 to the vehicle V.

Corresponding to the function of the coaxial connector 80a described above, a PoC filter 150 as a filter circuit is provided on the circuit board 40. The PoC filter 150 is electrically connected to the circuit board connector 47 and the switch 122, and can separate a part of the power supplied from the coaxial connector 80a and the power of the image signal output from the imaging element 50.

Accordingly, by using the PoC filter 150 to separate the power supplied from a power supply of the vehicle V via the coaxial connector 80a and the image signal from the imaging element 50, it is possible to transmit the image signal and the power in a superimposed manner through the coaxial connector 80a, which is a single coaxial cable, without adversely affecting signal quality.

A part of the original power supplied from the connector 80 is supplied to the switch 122 via the coaxial connector 80a and the PoC filter 150. Accordingly, a part of the original power is supplied to the switch 122, and the switch 122 can increase or decrease the voltage and/or current supplied to the heater 10. Instead of the PoC filter 150, another filter circuit may be used.

The piezoelectric element circuit portion 130 includes a conducting wire connector 131. The conducting wire connector 131 is disposed on the circuit board 40, is connected to the fourth conducting wire end 23 of the second conducting wire 21 and is also connected to the circuit board connector 47 (see FIG. 10). The conducting wire connector 131 functions as a conducting wire connection portion that connects the second conducting wire 21 to the circuit board 40.

The connector 80 includes a bi-pin connector 80b including a male terminal and a female terminal. The bi-pin connector 80b receives an ultrasonic signal for driving the piezoelectric element 20 from the vehicle V and outputs the ultrasonic signal to the conducting wire connector 131. The conducting wire connector 131 outputs the ultrasonic signal to the piezoelectric element 20 via the second conducting wire 21.

Regarding the camera circuit portion 140, a serializer 141 is provided on the circuit board 40. The serializer 141 can be disposed on the first surface 40a or the second surface 40b of the circuit board 40, and is electrically connected to the circuit board connector 47 and the imaging element 50.

The image signal output from the imaging element 50 is a parallel signal. On the other hand, a signal suitable for handling by the coaxial connector 80a is a serial signal. The serializer 141 serves to convert a parallel signal (image signal) output from the imaging element 50 into a serial signal (parallel-serial conversion) and output the serial signal to the coaxial connector 80a.

Accordingly, the serializer 141 can convert the parallel signal output from the imaging element 50 into a serial signal suitable for the coaxial connector 80a without signal synchronization.

Further, a power supply integrated circuit (IC) 143 is provided on the circuit board 40. The power supply IC 143 can be disposed on the first surface 40a or the second surface 40b of the circuit board 40, and is electrically connected to the PoC filter 150, the imaging element 50, and the serializer 141. The power supply IC 143, for a specific application, not only combines a plurality of power supplies necessary for the system, but also performs power supply control such as control of a power supply activation sequence according to the system and on/off control of each power supply for reducing power consumption, and is also called a power management IC. The power supply IC 143 is, for example, a power management IC (PMIC).

A part of the power supplied from the coaxial connector 80a is supplied to the power supply IC 143 via the PoC filter 150, and then supplied from the power supply IC 143 to the imaging element 50 and the serializer 141. Accordingly, the power supply IC 143 can secure the power for driving the imaging element 50 and the serializer 141.

The camera ECU (ECU) 111 inputs and outputs a power supply overlapping signal in which the power supplied to the power supply IC 143 and the switch 122 via the PoC filter 150 overlaps with the image signal output from the serializer 141. An ultrasonic transmission circuit 112 outputs an ultrasonic signal for driving the piezoelectric element 20. The camera ECU 111 and the ultrasonic transmission circuit 112 may be provided in the vehicle V or may be provided in the vehicular camera 100.

### Power Supply Procedure

FIG. 16 is a flowchart illustrating a power supply procedure in the vehicular camera 100. In this example, it is assumed that the temperature sensor (not illustrated) is provided near the first lens 35a. The camera ECU 111 activates the temperature sensor at a predetermined timing, such as during departure of the vehicle V (step S1). The camera ECU 111 reads a value from the temperature sensor (temperature of the first lens 35a or temperature of a vicinity of the first lens 35a) (step S2). The camera ECU 111 determines whether the read value is lower than a predetermined temperature (threshold temperature) (step S3). If the read value is lower than the predetermined temperature (step S3; Yes), the heater 10 is turned on, and a timer for measuring an activation time of the heater 10 is activated (step S4). After the heater 10 and the timer are activated, or if the value read from the temperature sensor is equal to or higher than the predetermined temperature (step S3; No), the ultrasonic transmission circuit 112 determines whether to remove water droplets (moisture) adhering to the first lens 35a (step S5). When the water droplets are removed, the ultrasonic transmission circuit 112 turns on the piezoelectric element 20 (step S6).

After the piezoelectric element 20 is turned on or if the water droplets adhering to the first lens 35a are not removed (step S5; No), the camera ECU 111 determines whether a count of the timer exceeds a predetermined time (step S7). If the count exceeds the predetermined time (step S7; Yes), the camera ECU 111 turns off the heater 10 (step S8). Further, the ultrasonic transmission circuit 112 determines whether to continue removing water droplets (step S9). If the removal of the water droplets is not continued (step S9; No), the ultrasonic transmission circuit 112 turns off the piezoelectric element 20 (step S10), and the process returns to step S2.

Another configuration of the vehicular camera 100 will be described. As illustrated in FIG. 15, the connector 80 may include a pin connector or a coaxial connector, or may include both a pin connector and a coaxial connector. Accordingly, the connector 80 can be easily configured.

The heater 10 may be a positive temperature coefficient (PTC) heater. Accordingly, power consumption can be reduced.

The connector 80 includes a first connector end portion 81 connected to the circuit board connector 47, and a second connector end portion 82 opposite to the first connector end portion 81 and connectable to a cable of the vehicle V. Accordingly, the connector 80 can supply power from the vehicle V to the circuit board connector 47.

The circuit board 40 may include a first circuit board and a second circuit board. Accordingly, components can be disposed on each of the plurality of circuit boards 40.

The circuit board connector 47 is disposed on the second surface 40b of the circuit board 40. Accordingly, in the circuit board 40, the circuit board connector 47 can be disposed on the second surface 40b opposite to the first surface 40a on which the imaging element 50 is disposed.

FIG. 17 is a cross-sectional view taken along the line I-I in FIG. 9 of the vehicular camera 100 according to an embodiment having two circuit boards. The appearance of the vehicular camera 100 according to the present embodiment is the same as the appearance in the above-described embodiment. A first circuit board 40A and a second circuit board 40B, which are the two circuit boards, are accommodated in the housing 60.

The first circuit board 40A is disposed closer to the first end portion 30a of the lens barrel 30 than the second circuit board 40B along the optical axis L, and the imaging element 50 is disposed on the first surface 40a of the first circuit board 40A. A spacer 90 made of resin is disposed between the first circuit board 40A and the second circuit board 40B to fill a space between the two circuit boards, thereby ensuring rigidity of each circuit board. In addition, a first board connector 43 provided on the first circuit board 40A and a second board connector 44 provided on the second circuit board 40B are connected to ensure electrical connection between the first circuit board 40A and the second circuit board 40B. The spacer 90, the first board connector 43, and the second board connector 44 are not essential.

In the present embodiment, the components can be disposed on each of the first circuit board 40A and the second circuit board 40B, and the degree of freedom in the number and types of components to be mounted can be further ensured. The number of circuit boards may be three or more.

As described above, at least the following matters are described in the present disclosure. Components corresponding to those in the embodiment are illustrated in parentheses, but the present disclosure is not limited thereto.
(1) A vehicular camera including:
a lens barrel (lens barrel 30) having a first tubular portion along an optical axis (optical axis L), and including a first end portion (first end portion 30a) of the first tubular portion, a second end portion (second end portion 30b) opposite to the first end portion, and a lens (lens 35) including at least a first lens (first lens 35a) and a second lens (second lens 35b) disposed along the optical axis;
an imaging element (imaging element 50) disposed on the optical axis and closer to the second end portion than the first end portion of the first tubular portion of the lens barrel;
a circuit board (circuit board 40) including a first surface (first surface 40a) and a second surface (second surface 40b) opposite to the first surface, the imaging element being disposed on the first surface;
a circuit board connector (circuit board connector 47) disposed on the circuit board; a housing (housing 60) having a second tubular portion along the optical axis, including a third end portion (third end portion 63) of the second tubular portion and a fourth end portion (fourth end portion 64) opposite to the third end portion and disposed farther, than the third end portion of the second tubular portion, away from the first end portion of the first tubular portion of the lens barrel, the third end portion of the second tubular portion supporting the lens barrel, and configured to accommodate the circuit board; and
a connector (connector 80) disposed in at least a part of the fourth end portion of the housing and connected to the circuit board connector, in which
the first lens is adjacent to the second lens and is disposed farther, than the second lens, away from the first surface of the circuit board in a direction along the optical axis,
the lens barrel includes
a heater (heater 10) having a first ring shape and disposed between the first lens and the second lens along a first edge portion (first edge portion 35a1) of the first lens,
a piezoelectric element (piezoelectric element 20) having a second ring shape and disposed between the first lens and the second lens along the first edge portion of the first lens, and
a resin member (resin member 70) having a third ring shape and disposed between the first lens and the second lens along a second edge portion (second edge portion 35b1) of the second lens,
the resin member of the lens barrel is disposed closer to the second lens than the heater of the lens barrel,
the resin member of the lens barrel is disposed closer to the second lens than the piezoelectric element of the lens barrel,
the resin member of the lens barrel supports the heater of the lens barrel and/or the piezoelectric element of the lens barrel, and
a first thermal conductivity of the lens barrel is larger than a second thermal conductivity of the resin member.

Accordingly, it is possible to remove different types of foreign matter such as snow and moisture adhering to the first lens by the heater and the piezoelectric element, and it is possible to secure the field of view of the vehicular camera. In addition, since the resin member having a thermal conductivity lower than that of the lens barrel supports the heater and/or the piezoelectric element, it is possible to prevent heat from the heater from being dissipated to the outside, and to efficiently remove snow by the heater.
(2) The vehicular camera according to (1), in which
the piezoelectric element of the lens barrel is disposed closer to the imaging element than the heater of the lens barrel in the direction along the optical axis.

Accordingly, the heater can be disposed closer to the first lens than the piezoelectric element, and the snow can be efficiently removed by the heat from the heater.
(3) The vehicular camera according to (2), in which
the heater of the lens barrel is disposed in contact with the first edge portion of the first lens of the lens barrel,
the piezoelectric element of the lens barrel is disposed in contact with the heater of the lens barrel, and
the resin member of the lens barrel is disposed in contact with the piezoelectric element of the lens barrel.

Accordingly, the heater, the piezoelectric element, and the resin member can be disposed in a limited space.
(4) The vehicular camera according to (1), in which
the heater of the lens barrel is disposed closer to the imaging element than the piezoelectric element of the lens barrel in the direction along the optical axis.

Accordingly, the piezoelectric element can be disposed closer to the first lens than the heater, and the moisture can be efficiently removed by the vibration of the piezoelectric element.
(5) The vehicular camera according to (4), in which
the piezoelectric element of the lens barrel is disposed in contact with the first edge portion of the first lens of the lens barrel,
the heater of the lens barrel is disposed in contact with the piezoelectric element of the lens barrel, and
the resin member of the lens barrel is disposed in contact with the heater of the lens barrel.

Accordingly, the piezoelectric element, the heater, and the resin member can be disposed in a limited space.
(6) The vehicular camera according to (1), in which
the first tubular portion of the lens barrel includes an inner surface (inner surface 33a) and an outer surface (outer surface 33b),
a first outer peripheral edge (first outer peripheral edge 10a) of the heater of the lens barrel is disposed along the inner surface of the lens barrel,
a second outer peripheral edge (second outer peripheral edge 20a) of the piezoelectric element of the lens barrel is disposed along the inner surface of the lens barrel, and
a third outer peripheral edge (third outer peripheral edge 70a) of the resin member of the lens barrel is disposed along the inner surface of the lens barrel.

Accordingly, the heater, the piezoelectric element, and the resin member can be stably disposed on the inner surface of the lens barrel.
(7) The vehicular camera according to (1), in which
the first lens of the lens barrel is a lens farthest from the imaging element,
the heater unit of the lens barrel is able to heat the first lens of the lens barrel, and
the piezoelectric element of the lens barrel is able to vibrate the first lens of the lens barrel.

Accordingly, it is possible to remove the foreign matter of the first lens closest to an object to be captured, of the lens, by the heater and the piezoelectric element, and to secure the field of view of the vehicular camera.
(8) The vehicular camera according to (1), in which
the heater of the lens barrel includes
a first conducting wire (first conducting wire 11) having a first conducting wire end (first conducting wire end 12) and a second conducting wire end (second conducting wire end 13) opposite to the first conducting wire end, the first conducting wire end being connected to the heater and the second conducting wire end being connected to the circuit board, and
the piezoelectric element of the lens barrel includes
a second conducting wire (second conducting wire 21) having a third conducting wire end (third conducting wire end 22) and a fourth conducting wire end (fourth conducting wire end 23) opposite to the third conducting wire end, the third conducting wire end being connected to the piezoelectric element and the fourth conducting wire end being connected to the circuit board.

Accordingly, it is possible to supply power necessary for the heater and the piezoelectric element from the circuit board.
(9) The vehicular camera according to (8), in which
at least a part of the first conducting wire of the heater of the lens barrel and at least a part of the second conducting wire of the piezoelectric element of the lens barrel pass outward of the outer surface of the first tubular portion of the lens barrel and are connected to the circuit board.

Accordingly, at least a part of the first conducting wire and at least a part of the second conducting wire can be disposed in a space between the lens barrel and the housing, and the space can be effectively used.
(10) The vehicular camera according to (8), in which
at least a part of the first conducting wire of the heater of the lens barrel and at least a part of the second conducting wire of the piezoelectric element of the lens barrel pass inward of the inner surface of the first tubular portion of the lens barrel and are connected to the circuit board.

Accordingly, at least a part of the first conducting wire and at least a part of the second conducting wire can be disposed inside the lens barrel, and lengths of the first conducting wire and the second conducting wire can be shortened.
(11) The vehicular camera according to (8), in which
each of the first conducting wire of the heater of the lens barrel and the second conducting wire of the piezoelectric element of the lens barrel is a flexible printed circuit board.

Accordingly, the first conducting wire and the second conducting wire can be easily configured.
(12) The vehicular camera according to (11), in which
the flexible printed circuit board of the first conducting wire of the heater of the lens barrel and the flexible printed circuit board of the second conducting wire of the piezoelectric element of the lens barrel are integrated.

Accordingly, the first conducting wire and the second conducting wire can be integrated, and the vehicular camera can be easily assembled.
(13) The vehicular camera according to (8), in which
first power is supplied to the heater via the first conducting wire, and then second power is supplied to the piezoelectric element via the second conducting wire.

Accordingly, after the foreign matter such as snow adhering to the first lens is melted by the heat form the heater to form moisture, the moisture can be removed by the vibration of the piezoelectric element, and the foreign matter can be efficiently removed.
(14) The vehicular camera according to (13), in which
the first power and the second power are supplied from the connector and the circuit board connector.

Accordingly, the first power and the second power can be supplied from the outside.
(15) The vehicular camera according to (1), in which the connector is a pin connector and/or a coaxial connector.

Accordingly, the connector can be easily configured.
(16) The vehicular camera according to (1), in which
the heater is a positive temperature coefficient (PTC) heater.

Accordingly, power consumption can be reduced.
(17) The vehicular camera according to (1), in which the connector includes
a first connector end portion (first connector end portion 81) connected to the circuit board connector, and
a second connector end portion (second connector end portion 82) opposite to the first connector end portion and connectable to a cable of a vehicle.

Accordingly, the power from the vehicle can be supplied to the circuit board connector via the connector.
(18) The vehicular camera according to (1), in which
the circuit board includes a first circuit board and a second circuit board.

Accordingly, components can be disposed on each of a plurality of circuit boards.
(19) The vehicular camera according to (1), in which
the circuit board connector is disposed on the second surface of the circuit board.

Accordingly, in the circuit board, the circuit board connector can be disposed on the second surface opposite to the first surface on which the imaging element is disposed.

Although the embodiments have been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the embodiments described above may be combined freely in a range without departing from the gist of the invention.

### INDUSTRIAL APPLICABILITY

The present disclosure is useful for a vehicular camera capable of securing a field of view by removing foreign matter.

### CROSS-REFERENCE TO RELATED APPLICATIONS

This application is based on and claims priority under 35 USC 119 from Japanese Patent Application No. 2024-185204 filed on Oct. 21, 2024, the contents of which are incorporated herein by reference.

What is claimed is:

1. A vehicular camera comprising:
a lens barrel having a first tubular portion along an optical axis, and including a first end portion of the first tubular portion, a second end portion opposite to the first end portion, and a lens including at least a first lens and a second lens disposed along the optical axis;
an imaging element disposed on the optical axis and closer to the second end portion than the first end portion of the first tubular portion of the lens barrel;
a circuit board including a first surface and a second surface opposite to the first surface, the imaging element being disposed on the first surface;
a circuit board connector disposed on the circuit board;
a housing accommodating the circuit board and having a second tubular portion along the optical axis, including a third end portion of the second tubular portion and a fourth end portion opposite to the third end portion and disposed farther, than the third end portion of the second tubular portion, away from the first end portion of the first tubular portion of the lens barrel, the third end portion of the second tubular portion supporting the lens barrel; and
a connector disposed on at least a part of the fourth end portion of the housing and connected to the circuit board connector, wherein the first lens is adjacent to the second lens and is disposed farther, than the second lens, away from the first surface of the circuit board in a direction along the optical axis,
the lens barrel includes
a heater having a first ring shape and disposed between the first lens and the second lens along a first edge portion of the first lens,
a piezoelectric element having a second ring shape and disposed between the first lens and the second lens along the first edge portion of the first lens, and
a resin member having a third ring shape and disposed between the first lens and the second lens along a second edge portion of the second lens,
the resin member of the lens barrel is disposed closer to the second lens than the heater of the lens barrel,
the resin member of the lens barrel is disposed closer to the second lens than the piezoelectric element of the lens barrel,
the resin member of the lens barrel supports the heater of the lens barrel and/or the piezoelectric element of the lens barrel, and
a first thermal conductivity of the lens barrel is greater than a second thermal conductivity of the resin member.

2. The vehicular camera according to claim 1, wherein
the piezoelectric element of the lens barrel is disposed closer to the imaging element than the heater of the lens barrel in the direction along the optical axis.

3. The vehicular camera according to claim 2, wherein
the heater of the lens barrel is disposed in contact with the first edge portion of the first lens of the lens barrel,
the piezoelectric element of the lens barrel is disposed in contact with the heater of the lens barrel, and
the resin member of the lens barrel is disposed in contact with the piezoelectric element of the lens barrel.

4. The vehicular camera according to claim 1, wherein
the heater of the lens barrel is disposed closer to the imaging element than the piezoelectric element of the lens barrel in the direction along the optical axis.

5. The vehicular camera according to claim 4, wherein
the piezoelectric element of the lens barrel is disposed in contact with the first edge portion of the first lens of the lens barrel,
the heater of the lens barrel is disposed in contact with the piezoelectric element of the lens barrel, and
the resin member of the lens barrel is disposed in contact with the heater of the lens barrel.

6. The vehicular camera according to claim 1, wherein
the first tubular portion of the lens barrel includes an inner surface and an outer surface,
a first outer peripheral edge of the heater of the lens barrel is disposed along the inner surface of the lens barrel,
a second outer peripheral edge of the piezoelectric element of the lens barrel is disposed along the inner surface of the lens barrel, and
a third outer peripheral edge of the resin member of the lens barrel is disposed along the inner surface of the lens barrel.

7. The vehicular camera according to claim 1, wherein
the first lens of the lens barrel is a lens farthest from the imaging element,
the heater of the lens barrel is able to heat the first lens of the lens barrel, and
the piezoelectric element of the lens barrel is able to vibrate the first lens of the lens barrel.

8. The vehicular camera according to claim 1, wherein
the heater of the lens barrel includes a first conducting wire having a first conducting wire end and a second conducting wire end opposite to the first conducting wire end,
the first conducting wire end is connected to the heater,
the second conducting wire end is connected to the circuit board, and
the piezoelectric element of the lens barrel includes a second conducting wire having a third conducting wire end and a fourth conducting wire end opposite to the third conducting wire end,
the third conducting wire end is connected to the piezoelectric element, and
the fourth conducting wire end is connected to the circuit board.

9. The vehicular camera according to claim 8, wherein
at least a part of the first conducting wire of the heater of the lens barrel and at least a part of the second conducting wire of the piezoelectric element of the lens barrel pass outward of the outer surface of the first tubular portion of the lens barrel and are connected to the circuit board.

10. The vehicular camera according to claim 8, wherein
at least a part of the first conducting wire of the heater of the lens barrel and at least a part of the second conducting wire of the piezoelectric element of the lens barrel pass inward of the inner surface of the first tubular portion of the lens barrel and are connected to the circuit board.

11. The vehicular camera according to claim 8, wherein
each of the first conducting wire of the heater of the lens barrel and the second conducting wire of the piezoelectric element of the lens barrel is a flexible printed circuit board.

12. The vehicular camera according to claim 11, wherein
the flexible printed circuit board of the first conducting wire of the heater of the lens barrel and the flexible printed circuit board of the second conducting wire of the piezoelectric element of the lens barrel are integrated.

13. The vehicular camera according to claim 8, wherein
first power is supplied to the heater via the first conducting wire, and then second power is supplied to the piezoelectric element via the second conducting wire.

14. The vehicular camera according to claim 13, wherein
the first power and the second power are supplied from the connector and the circuit board connector.

15. The vehicular camera according to claim 1, wherein
the connector is a pin connector or a coaxial connector.

16. The vehicular camera according to claim 1, wherein
the heater is a positive temperature coefficient (PTC) heater.

17. The vehicular camera according to claim 1, wherein
the connector includes
a first connector end portion connected to the circuit board connector, and
a second connector end portion opposite to the first connector end portion and connectable to a cable of a vehicle.

18. The vehicular camera according to claim 1, wherein the circuit board includes a first circuit board and a second circuit board.

19. The vehicular camera according to claim 1, wherein
the circuit board connector is disposed on the second surface of the circuit board.
